(19) United States
(12) Patent Application Publication
(10) Pub. No.: US 2009/0320314 A1
(43) Pub. Date: Dec. 31, 2009

(54) DRYING MACHINE WITH MULTI-LAYERED DRYING CHAMBER

(75) Inventors: Seong Jin Jo, Gyeongsangnam-do (KR); Seong Hae Jeong, Gyeongsangnam-do (KR); Deug Hee Lee, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/310,312

(22) PCT Filed: Aug. 21, 2007
(86) PCT No.: PCT/KR2007/003978

§ 371 Date: Jun. 24, 2009

(30) Foreign Application Priority Data
Aug. 22, 2006 (KR) 10-2006-0079413

(51) Int. Cl. F26B 25/06; F26B 25/14

(52) U.S. Cl. 34/218; 34/239

(57) ABSTRACT

A multi-layer type drying machine (200) is disclosed. The multi-layer type drying machine (200) has a drying space divided into several sections in a multi-layered structure for receiving objects to be dried. The multi-layer type drying machine (200) includes a container (210-214) defining a drying space for receiving objects to be dried, a plurality of shelves (252-254) mounted in the drying space, such that the drying space is divided multi-layered structure, for allowing the objects to be placed thereon, and a hot air supply unit (230, 240) for supplying hot air into the drying space.

### TECHNICAL FIELD

The present invention relates to a drying machine with a multi-layered drying chamber, and more particularly, to a drying machine with a multi-layered drying chamber in which laundry articles to be dried are received.

### BACKGROUND ART

Generally, laundry treating apparatuses are electric home appliances that are capable of washing and/or drying laundry. Specifically, the respective laundry treating apparatuses perform a washing operation, a drying operation, or a washing-and-drying operation. Recently, there has been increasingly used a laundry treating apparatus, including a steam supply unit, that is capable of performing a refreshing operation to remove wrinkles, smells, and static electricity from laundry.

Based on the direction in which laundry is removed, the conventional laundry treating apparatuses are classified into a front loading type laundry treating apparatus and a top loading type laundry treating apparatus. Based on the washing method, on the other hand, the conventional laundry treating apparatuses are classified into a pulsator type laundry treating apparatus, a vertical-shaft type laundry treating apparatus, in which a washing tub is rotated, and a horizontal type laundry treating apparatus, in which a drum is rotated. A representative example of the horizontal type laundry treating apparatus is a drum type washing machine or a drum type drying machine.

The sizes of the laundry treating apparatuses have been gradually increased to satisfy consumers' demand. Specifically, the exterior sizes of the laundry treating apparatuses for home use have been gradually increased.

On the other hand, there is a washing machine having no drying function among the conventional laundry treating apparatuses. In this case, it is required for a user to have an additional large-sized drying machine, when the user wishes to dry laundry. Alliteratively, it is required for the user to have a washing machine including a drying function. Consequently, the expense that consumers bear to performing both the washing operation and the drying operation is increased.

Also, the size of the conventional drying machine is large. For this reason, when both a washing machine and a drying machine are installed, the installation space of the washing machine and the drying machine is greatly restricted.

Furthermore, the large-sized drying machine is operated even to dry a small quantity of laundry, with the result that energy consumption is excessively increased.

For the drum type drying machine, on the other hand, a drum is rotated to tumble laundry articles to be dried. Consequently, the drum type drying machine is not suitable for drying shoes.

When shoes need to be washed, a small number of shoes, for example one pair or two pairs of shoes, are normally washed. When the conventional drying machine is used to dry such a small quantity of something to be dried, it is required to drive the drum and, in addition, to drive a large-capacity heater and a large-capacity fan. Consequently, it is very inefficient in an energy saving aspect.

FIG. 1 is a perspective view illustrating a conventional laundry treating apparatus, specifically, a conventional drying machine.

As shown in FIG. 1, the conventional drying machine 1 includes machine body 10 forming the external appearance of the drying machine and a controller 30, including a control panel mounted at the front or the top of the machine body 10.

The illustrated drying machine is a drum type drying machine. Laundry articles to be dried are put in a drum, and hot air is supplied into the drum by a hot air supply unit (not shown), during the rotation of the drum, to perform a drying operation.

A user inputs a command for drying, such as a drying mode, through the control panel mounted at the front of the machine body 10. Accordingly, a main control unit of the controller drives the hot air supply unit to perform the drying operation.

The hot air supply unit includes a heater for heating air and a blowing fan for guiding the heated air to the drum.

### DISCLOSURE OF INVENTION

### Technical Problem

An object of the present invention devised to solve the problem lies on a multi-layer type drying machine that is capable of performing a drying operation without driving a drum, unlike a conventional drum type drying machine, and has a multi-layered drying chamber, thereby drying a small quantity of laundry articles to be dried with high energy efficiency.

Another object of the present invention devised to solve the problem lies on a multi-layer type drying machine that is capable of drying laundry articles, such as shoes or hats, which are not suitably dried by a conventional drying machine.

Another object of the present invention devised to solve the problem lies on a multi-layer type drying machine that is installed at the left or right side of a conventional drying machine or a conventional washing machine to increase the utility of the conventional drying machine or the conventional washing machine, and is installed without a spatial restriction.

A further object of the present invention devised to solve the problem lies on a multiple laundry treating apparatus constructed in a compact structure, including a drying machine or a washing machine, for performing a drying operation or a washing operation.

### Technical Solution

The object of the present invention can be achieved by providing a multi-layer type drying machine including a container defining a drying space for receiving objects to be dried, a plurality of shelves mounted in the drying space, such that the drying space is divided into several sections in a multi-layered structure, for allowing the objects to be placed thereon, and a hot air supply unit for supplying hot air into the drying space.

Preferably, the width of the container is less than the height of the container, and the height of the container is approximately equal to that of a laundry machine, which may be a drying machine or a washing machine. Consequently, the multi-layer type drying machine may be suitably installed at the left side or the right side of the laundry machine. Also, the multi-layer type drying machine may be suitable for drying a small quantity of laundry.

Since the width of the container is relatively small, it is possible to install the multi-layer type drying machine at one side of the laundry machine even in a small space. Consequently, the installation of the multi-layer type drying machine is accomplished without a spatial restriction.

The multi-layer type drying machine may be combined with a washing machine. Alternatively, the multi-layer type drying machine may be combined with a drying machine. In addition, the multi-layer type drying machine may be combined with a washing machine and a drying machine.

The shelves are mounted in the multi-layer type drying machine. Consequently, the multi-layer type drying machine is very suitable for drying shoes. Shoes are not suitably dried by a drum type washing machine die to the rotation of a drum of the drum type drying machine. Also, unlike clothes, the spin-drying process of the shoes is not properly performed die to the soles of the shoes. For this reason, drying the shoes, containing a large amount of moisture, using a large-sized drying machine, such as a conventional drum type drying machine is not efficient in an energy saving aspect.

When it is necessary to wash shoes, a small number of shoes, for example one pair or two pairs of shoes, are normally-washed. Driving the large-sized drying machine, such as the drum type drying machine, to dry such a small quantity of shoes, is another energy waste factor.

Also, when shoes are wetted due to rain or snow, it is necessary to dry the wet shoes. However, a large amount of filth may stick to the soles of the shoes, with the result that drying the shoes using the drying machine, such as the drum type drying machine, is not suitable. For the drum type drying machine, on the other hand, the drum is rotated to tumble laundry articles to be dried. Consequently, the drum type drying machine is less and less suitable for drying the shoes, to the soles of which filth sticks.

In addition, it is not preferable to dry the shoes using the conventional drying machine, which is used mainly to dry clothes, in a sanitary aspect. Especially, underclothes must be sanitarily treated.

The multi-layer type drying machine according to the present invention may be constructed in a structure especially suitable for drying shoes. The plurality of shelves are mounted in the multi-layer type drying machine, and therefore, it is possible to dry several pairs of shoes while the shoes are placed on the respective shelves in the multi-layered structure.

The washing of the shelves is easily accomplished. When the shelves are constructed such that the shelves are detachably mounted in the multi-layer type drying machine, the washing of the shelves is more easily accomplished. Also, when the shelves are constructed such that the shelves are withdrawn outward from the multi-layer type drying machine, the washing of the shelves is more easily accomplished. In this case, the insertion and removal of shoes into and from the multi-layer type drying machine are very convenient.

The shelves may be mounted in the drying space in an inclined fashion. In this case, shoes are placed on the respective shelves in an inclined fashion, with the result that water contained in the shoes are collected in the lower portions of the shoes, and therefore, the shoes are more efficiently dried.

Each shelf may be provided with a plurality of through-holes, through which air circulation between the respective layers is smoothly accomplished.

The lower shelves may be used to dry shoes, and the upper shelves may be used to dry small-sized clothes. Here, the small-sized clothes may be hats.

The hats are not also suitably spin-dried by the high-speed rotation of a spin-drying drum. It is required for the hats to maintain their shapes. However, the hats may be deformed after-the-high-speed centrifugal spin-drying process. Furthermore, various ornaments are generally attached to the hats, and the ornaments may be damaged after the centrifugal spin-dying process.

For this reason, it is necessary to dry the hats, containing a large amount of moisture, without spin drying the heats. However, driving a large-capacity heater and a large-capacity blowing fan, while rotating the drum, is inefficient in an energy saving aspect. In this case, therefore, drying the hats using a small-capacity heater and a small-capacity blowing fan for a long period of time in a power saving mode is efficient in an energy saving aspect.

The multi-layer type drying machine according to the present invention may be constructed such that the multi-layer type drying machine is dependent on the laundry machine, such as a washing machine or a drying machine, in connection with hot air. Alternatively, the multi-layer type drying machine may be independent of the laundry machine in connection with hot air.

As an example of the dependent structure, the hot air supply unit may be mounted in the laundry machine for performing a drying operation. In this case, the laundry machine is constructed in a structure to supply hot air to the outside. For example, the laundry machine may have a pipe, through which hot air, generated by the heater and the blowing fan mounted in the laundry machine, is supplied to the outside. Correspondingly, the container is provided with an inlet port, to which the pipe is connected such that the hot air is supplied into the drying space.

Preferably, the operation of the hot air supply unit is controlled in the laundry machine. In this case, the container is disposed at one side of the laundry machine to provide an additional multi-layered drying space in which laundry articles to be dried are received.

On the other hand, the operation of the hot air supply unit may be controlled by the multi-layer type drying machine according to the present invention, according to circumstances. To this end, the container may be provided with a main control unit for controlling the operation of the hot air supply unit mounted in the laundry machine.

Also, an input unit for allowing a user to input a command for operating the multi-layer type drying machine according to the present invention may be mounted in the container. Alternatively, the input unit may be mounted in the laundry machine.

In the former case, only the hot air supply unit is mounted in the laundry machine, whereas the input unit and the main control unit are mounted in the container. To this end, the hot air supply unit of the laundry machine and the main control unit of the container are electrically-connected to each other.

In the latter case, the hot air supply unit and the main control unit, for controlling the hot air supply unit, are mounted in the laundry machine, whereas the input unit, for allowing the user to input a command for drying, such as a drying mode, necessary to operate the multi-layer type drying machine according to the present invention, is mounted in the container.

In this case, the input unit, for allowing the user to input a command for drying, of the nmulti-layer type drying machine according to the present invention may be constructed differently from that of the laundry machine as described above, and therefore, it is not necessary to change the laundry machine to a great extent.

As an example of the independent structure, on the other hand, the hot air supply unit may be mounted in the container.

The container may be provided at one side wall thereof with an inlet port communicating with the lower part of the drying space and an outlet port communicating with the upper part of the drying space.

In this case, the hot air supply unit may include a heater mounted in a channel defined between the inlet port and the drying space, and a blowing fan mounted in a channel defined between the drying space and the outlet port.

As air is discharged from the drying space to the outside by the operation of the blowing fan, external air is introduced into the container through the inlet port The air, introduced through the inlet port, is heated by the heater, and is then glided into the drying space to dry laundry articles to be dried.

The heater is mounted at the bottom of the container. This is preferred in a safety and efficiency aspect. If the heater is mounted at the top of the container, the heater is located near the upper body part of the user, which is not preferred in a safety aspect Also, hot air moves upward, and therefore, it is preferred in an efficiency aspect that the heater is mounted at the bottom of the container.

The heater and the blowing fan may be mounted to different side walls of the container or the same side wall of the container.

Even when the hot air supply unit is mounted in the container as described above, the operation of the hot air supply unit may be controlled by the laundry machine. Preferably, however, the main control unit, for controlling the operation of the hot air supply unit, is also mounted in the container.

Also, the input unit, for allowing the user to input a command for drying, such as a drying mode, may be mounted in the laundry machine. Even in this case, however, the input unit is preferably mounted in the container.

The main control unit is a unit for controlling the operation of the hot air supply unit according to a command inputted by the user through the input unit. The main control unit generally includes a microprocessor.

On the other hand, the multi-layer type drying machine according to the present invention may further include a steam supply unit for supplying steam into the drying space. Like the hot air supply unit, the steam supply unit may be mounted in the container or the laundry machine.

The operation of the steam supply unit is controlled in the same manner as the hot air supply unit. Specifically, the control unit, for controlling the operation of the steam supply unit, may be mounted in the container or the laundry machine.

When even at least some components of the laundry machine are utilized in constructing the multi-layer type drying machine according to the present invention, it is required for the multi-layer type drying machine and the laundry machine to be electrically connected to each other, or for the connection between the multi-layer type drying machine and the laundry machine to be accomplished such that hot air is transmitted from the laundry machine to the multi-layer type drying machine. How to concretely accomplish such a connection may be easily derived from the conventional art and may be appropriately selected by a person who wishes to construct the multi-layer type drying machine according to the present invention. Accordingly, a detailed description of how to concretely accomplish such a connection will not be given.

In another aspect of the present invention, provided herein is a multiple laundry treating apparatus including a laundry machine for performing a washing or drying operation, a multi-layer type drying machine including a container defining a drying space for receiving objects to be dried, the container being located at the left side or the right side of the laundry machine, and a plurality of shelves mounted in the drying space, such that the drying space is divided into several sections in a multi-layered structure, for allowing the objects to be placed thereon, and a hot air supply unit for supplying hot air into the drying space.

The laundry machine for performing the washing or drying operation may be a washing machine or a drying machine.

When the above-described multiple laundry treating apparatus is constructed, the laundry machine for performing the washing or drying operation and the multi-layer type drying machine may be constructed in various structures as previously described. Specifically, the laundry machine and the multi-layer type drying machine may be constructed in a dependent structure or an independent structure.

### ADVANTAGEOUS EFFECTS

According to the present invention with the above-described construction, the multi-layer type drying machine is capable of performing a drying operation without driving the drim, unlike the conventional drying machine, and effectively drying a small quantity of laundry articles to be dried. Consequently, the present invention has the effect of improving energy efficiency.

Also, the multi-layer type drying machine according to the present invention is capable of drying laundry articles, such as shoes or hats, which are not suitably dried by the conventional drying machine.

Also, the multi-layer type drying machine according to the present invention is installed at the left or right side of the conventional drying machine or the conventional washing machine to increase the utility of the conventional drying machine or the conventional washing machine, and the installation of the multi-layer type drying machine is accomplished without a spatial restriction.

Furthermore, the multi-layer type drying machine according to the present invention is combined with the conventional drying machine or the conventional washing machine to construct a multiple laundry treating apparatus for performing a drying operation or a washing operation in a compact structure. Consequently, the present invention has the effect of accomplishing more convenient use of the multi-layer type drying machine and the conventional drying machine or the conventional washing machine and improving the utility of the multi-layer type drying machine and the conventional drying machine or the conventional washing machine.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a perspective view illustrating a conventional drying machine.

FIG. 2 is an exploded perspective view illustrating an embodiment of a drying machine with a multi-layered drying chamber according to the present invention;

FIG. 3 is a perspective view illustrating an embodiment of a multiple laundry treating apparatus according to the present invention; and

FIGS. 4 to 7 are views illustrating various embodiments of the drying machine with the multi-layered drying chamber and the multiple laundry treating apparatus according to the present invention.

### BEST MODE FOR CARRYING OUT THE INVENTION

Reference will now be made in detail to the preferred embodiments of the present invention, examples of which are illustrated in the accompanying drawings.

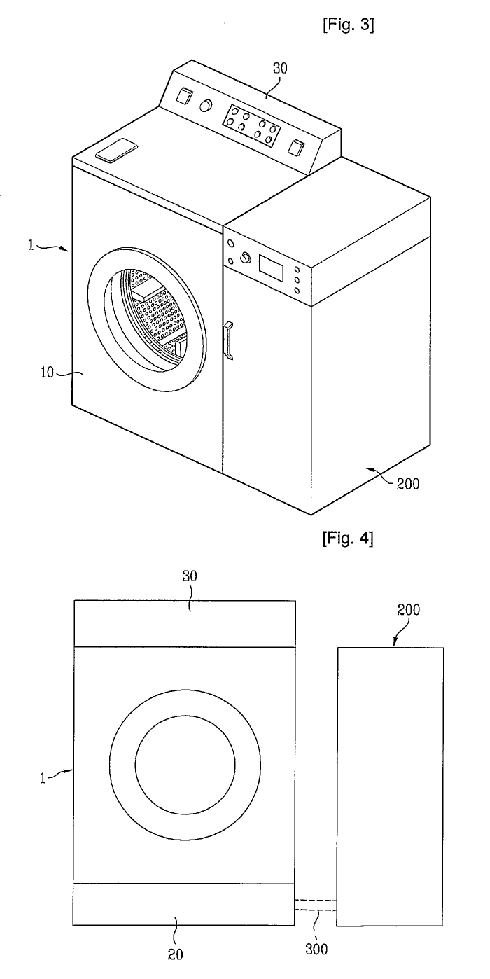

FIG. 2 is an exploded perspective view illustrating an embodiment of a drying machine with a multi-layered drying chamber according to the present invention. In this drying machine, the control of hot air and a hot air supply unit is performed in a completely independent fashion.

To the front of a container, defining a drying space of the drying machine, is mounted a door 211. The container includes a left side wall 212, a right side wall 213, a rear wall 214, and a bottom 210.

In the drying space, defined in the container, are mounted a plurality of shelves 251 to 253. The respective shelves 251 to 253 have pluralities of through-holes 254 for hot air circulation.

The shelves 251 to 253 are inclined downward toward the front of the container. Here, the shelves 251 to 253 may have different inclinations.

The shelves 251 to 253 are detachably mounted in the container. In this embodiment, the left side wall 212 and the right side wall 213 of the container are provided with grooves 217, in which the respective shelves 251 to 253 are slidably supported.

The shelves 251 to 253 may be slid along the grooves 217 such that the shelves 251 to 253 can be withdrawn outward.

Consequently, it is possible for a user to open the door 211, to withdraw the respective shelves 251 to 253 outward in a sliding fashion, and to place laundry articles to be dried.

Also, a hot air supply unit is mounted in the container. The hot air supply unit includes a heater 230 mounted at the bottom of the container and a blowing fan 240 mounted at the top of the container.

The right side wall 213 is provided with an inlet port 215 and an outlet port 216 corresponding to the heater 230 and the blowing fan 240, respectively.

Specifically, the heater 230 is located in a channel defined between the inlet port 215 and the drying space, and the blowing fan 240 is located in a channel defined between the drying space and the outlet port 216.

Consequently, when the blowing fan 240 is operated, air is discharged from the drying space to the outside through the outlet port 216, and external air is introduced through the inlet port 215. The introduced air is heated by the heater 230 before the air is guided to the drying space.

In this embodiment, a steam supply unit 260 is mounted in the container. Steam, supplied from the steam supply unit 260, serves to sterilize the laundry articles or remove a smell from the laundry articles.

In this embodiment, the drying machine, having the multi-layered drying chamber as described above, is controlled by a controller 220. As shown in the drawing, the controller 220 includes a main control unit 218, an input unit, and a display unit.

The input unit includes various selection buttons 221 and a knob 222 for allowing a user to select a drying mode.

The main control unit 218 controls the operation of the hot air supply unit and the steam supply unit 260 according to a command inputted by the user through the input unit.

The main control unit 218 includes a microprocessor to control the operation of the hot air supply unit and the steam supply unit 260 based on a control algorithm programmed according to the drying mode inputted by the user.

The display unit serves to display information selected by the user or information related to the drying during the drying operation. To this end, the display unit includes a liquid crystal display (LCD) 223 and various light emitting diodes (LEDs) 224.

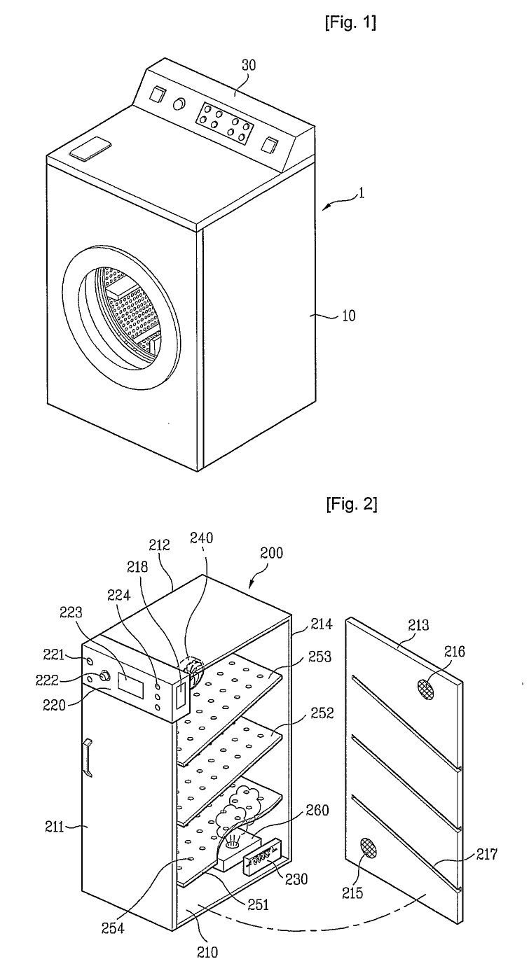

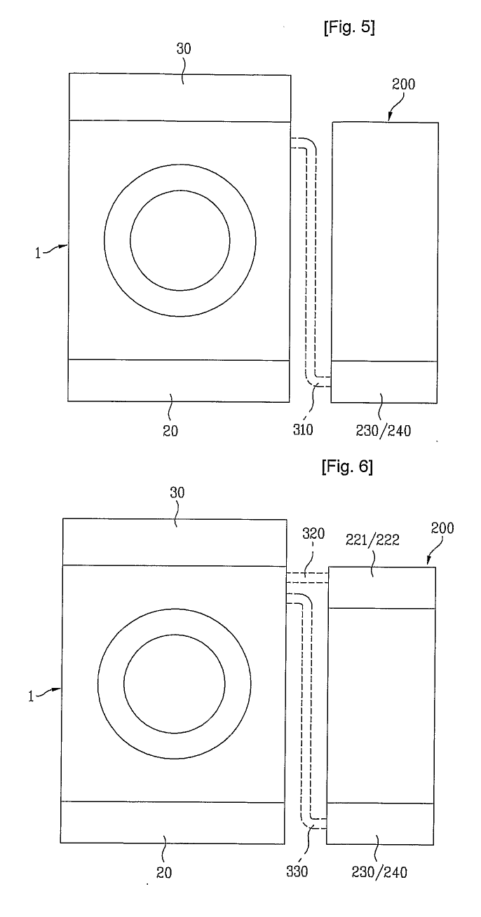

On the other hand, FIG. 3 is a perspective view illustrating a multiple laundry treating apparatus including a drying machine 200 with a multi-layered drying chamber as shown in FIG. 2 and a drum type drying machine 1 as shown in FIG. 1, which are arranged side by side. Here, it is possible to use a washing machine instead of the drum type drying machine.

As shown in the drawing, the multi-layer type drying machine 200 has a height equal to that of the drum type drying machine 1. Also, the multi-layer type drying machine 200 has a width less than that of the drum type drying machine 1. In this embodiment, the multi-layer type drying machine 200 has a width sufficient to receive a pair of adult shoes or so.

Although not shown in the drawing, the drum type drying machine 1 and the multi-layer type drying machine 200 may be coupled to each other by a coupling unit. The multi-layer type drying machine 200 has a relatively large height and a relatively small width, with the result that the multi-layer type drying machine 200 may fall easily on the left side or the right side. For this reason, the multi-layer type drying machine 200 is preferably fixedly coupled to the drum type drying machine 1 by the coupling unit.

Generally, vibrations are generated from the drying machine or the washing machine daring the rotation of the drum, and the multi-layer type drying machine 200 may fall more easily on the left side or the right side die to the vibrations. For this reason, the provision of the coupling unit is more and more necessary.

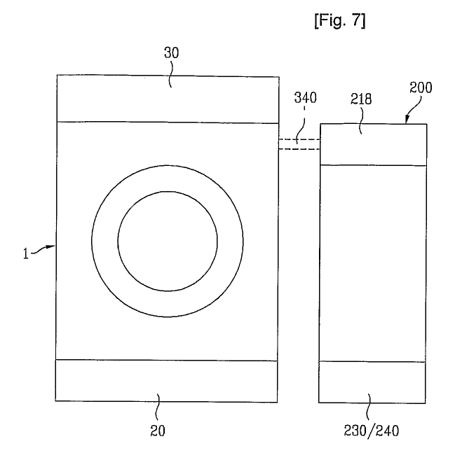

On the other hand, FIGS. 4 to 7 are views conceptionally illustrating various embodiments of the drying machine with the multi-layered drying chamber and the multiple laundry treating apparatus for performing a washing operation or a drying operation according to the present invention. Here, a laundry machine for performing a washing operation or a drying operation, constituting the multiple laundry treating apparatus, is a drum type drying machine.

Referring first to FIG. 4, the multi-layer type drying machine 200 includes a container, defining a drying space, which is separated from the drum type drying machine 1; however, a hot air supply unit 20, a main control unit for controlling the hot air supply unit, and an input unit are mounted in the drum type washing machine 1. Specifically, the main control unit and the input unit are mounted in a controller 30 of the drum type washing machine 1.

In this case, therefore, the container of the multi-layer type drying machine 200 is connected to the drum type washing machine 1 via a transmission channel 300, along which hot air is transmitted from the drum type washing machine 1 to the multi-layer type drying machine 200.

Referring to FIG. 5, a hot air supply unit 230/240 is separately mounted in the container of the multi-layer type drying machine 200. However, the main control unit for controlling the hot air supply unit 230/240 and the input unit are mounted in the dram type washing machine 1 in the same manner as shown in FIG. 4.

A user inputs a command for operating the multi-layer type drying machine 200 through the controller 30 mounted in the drum type washing machine 1. Accordingly, the main control unit of the controller drives the hot air supply unit 230/240 mounted in the container of the multi-layer type drying machine 200.

In this case, the hot air supply unit 230/240 of the multi-layer type drying machine 200 is electrically connected to the main control unit of the controller 30 of the drum type washing machine 1 via an electrical connection unit 310.

Referring to FIG. 6, the hot air supply unit 230/240 and an input unit 221/222 are mounted in the container of the multi-layer type drying machine 200, and the controller 30, including the main control unit for controlling the operation of the hot air supply unit 230/240, is mounted in the drum type washing machine 1.

A user inputs an operation command through the input unit mounted in the container. Accordingly, the main control unit of the controller, mounted in the drum type washing machine 1, controls the operation of the hot air supply unit 230/240, mounted in the container of the multi-layer type drying machine 200.

In this case, the input unit 221/222 of the multi-layer type drying machine 200 and the main control unit of the drum type washing machine 1 are electrically connected to each other via an electric connection unit 320. Also, the main control unit of the drum type washing machine 1 and the hot air supply unit 230/240 of the multi-layer type drying machine 200 are electrically connected to each other via another electric connection unit 330.

Referring to FIG. 7, the hot air supply unit 230/240 and a main control unit 218 are mounted in the container of the multi-layer type drying machine 200, and the input unit is mounted in the controller 30 of the drum type washing machine 1.

A user inputs a command for operating the multi-layer type drying machine 200 through the input unit mounted in the controller 30 of the drum type washing machine 1. Accordingly, the main control unit 218, mounted in the container of the multi-layer type drying machine 200, controls the operation of the hot air supply unit 230/240, mounted in the container of the multi-layer type drying machine 200.

In this case, the input unit of the drum type washing machine 1 and the main control unit 218 of the multi-layer type drying machine 200 are electrically connected to each other via an electric connection unit 340.

Although not shown in the accompanying drawings, it is possible to construct the multi-layer type drying machine and the multiple laundry treating apparatus in other structures different from the structures shown in FIGS. 4 to 7.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As apparent from the above description, the multi-layer type drying machine according to the present invention is capable of performing a drying operation without driving the drum, unlike the conventional drying machine, and effectively drying a small quantity of laundry articles to be dried. Consequently, the present invention has the effect of improving energy efficiency.

Also, the multi-layer type drying machine according to the present invention is capable of drying laundry articles, such as shoes or hats, which are not suitably dried by the conventional drying machine.

Also, the multi-layer type drying machine according to the present invention is installed at the left or right side of the conventional drying machine or the conventional washing machine to increase the utility of the conventional drying machine or the conventional washing machine, and the installation of the multi-layer type drying machine is accomplished without a spatial restriction.

Furthermore, the multi-layer type drying machine according to the present invention is combined with the conventional drying machine or the conventional washing machine to construct a multiple laundry treating apparatus for performing a drying operation or a washing operation in a compact structure. Consequently, the present invention has the effect of accomplishing more convenient use of the multi-layer type drying machine and the conventional drying machine or the conventional washing machine and improving the utility of the multi-layer type drying machine and the conventional drying machine or the conventional washing machine.

1. A multi-layer type drying machine comprising:
a container defining a drying space for receiving objects to be dried;
a plurality of shelves mounted in the drying space, such that the drying space is divided into several sections in a multi-layered structure, for allowing the objects to be placed thereon; and
a hot air supply unit for supplying hot air into the drying space.

2. The drying machine according to claim 1, wherein at least some of the shelves are detachably mounted in the drying space.

3. The drying machine according to claim 1, wherein each shelf has a plurality of through-holes.

4. The drying machine according to claim 1, wherein the drying space is used exclusively to dry shoes.

5. The drying machine according to claim 4, wherein the shelves are mounted in the drying space in an inclined fashion.

6. The drying machine according to claim 1, wherein the container is provided at one side wall thereof with an inlet port communicating with the lower part of the drying space and an outlet port communicating with the upper part of the drying space, and
the hot air supply unit includes
a heater mounted in a channel defined between the inlet port and the drying space, and
a blowing fan mounted in a channel defined between the drying space and the outlet port.

7. The drying machine according to claim 1, further comprising:
a steam supply unit for supplying steam into the drying space.

8. The drying machine according to claim 1, further comprising:
an input unit mounted in the container for allowing a user to input an operation command.

9. The drying machine according to claim 1, further comprising:
a main control unit mounted in the container for controlling the operation of the hot air supply unit.

10. A multiple laundry treating apparatus comprising:
a laundry machine for performing a washing or drying operation;
a multi-layer type drying machine including a container defining a drying space for receiving objects to be dried, the container being located at the left side or the right side of the laundry machine, and a plurality of shelves mounted in the drying space, such that the drying space is divided into several sections in a multi-layered structure, for allowing the objects to be placed thereon; and
a hot air supply unit for supplying hot air into the drying space.

11. The multiple laundry treating apparatus according to claim 10, wherein the hot air supply unit is mounted in the laundry machine.

12. The multiple laundry treating apparatus according to claim 11, further comprising:
a main control unit for controlling the operation of the hot air supply unit; and
an input unit for allowing a user to input an operation command, wherein the main control unit and the input unit are mounted in the laundry machine.

13. The multiple laundry treating apparatus according to claim 10, wherein the hot air supply unit is mounted in the multi-layer type drying machine.

14. The multiple laundry treating apparatus according to claim 13, further comprising:
a main control unit for controlling the operation of the hot air supply unit; and
an input unit for allowing a user to input an operation command.

15. The multiple laundry treating apparatus according to claim 14, wherein the main control unit and the input unit are mounted in the laundry machine.

16. The multiple laundry treating apparatus according to claim 14, wherein
the main control unit is mounted in the laundry machine, and
the input unit is mounted in the multi-layer type drying machine.

17. The multiple laundry treating apparatus according to claim 14, wherein
the main control unit is mounted in the multi-layer type drying machine, and the input unit is mounted in the laundry machine.
